(19) United States
(12) Patent Application Publication
(10) Pub. No.: US 2004/0020062 A1
(43) Pub. Date: Feb. 5, 2004

(54) Foldable handsaw

(75) Inventor: Lucien C. Ducret, (US)

Correspondence Address: PAUL J. FARRELL, ESQ., DILWORTH & BARRESE, LLP, 333 Earle Ovington Blvd., Uniondale, NY, 11553, US

(73) Assignee: SEATEK CO., INC., Stamford, CT

(21) Appl. No.: 10/209,371

(22) Filed: Jul. 30, 2002

(51) Int. Cl. B23D 51/03; B27B 21/06

(52) U.S. Cl. 30/512; 30/513; 30/506; 30/507

(57) ABSTRACT

A hand saw is provided with a support having a front lever, which is pivotable about one of the opposite ends of the support between a rest position, in which it extends coplanar with the support, to an operative position, and a handle mounted on the other end of the support and rotatable thereabout from and in a respective rest position, in which the handle extends coplanar to the support, so as to the hand saw has substantially a linear configuration when the front lever and the handle are displaced in their rest positions.

### FIELD OF INVENTION

[1] The invention relates to handsaws, and more particularly, to a hacksaw having a plurality of pivotable components interacting with one another to provide the hacksaw with a compact portable structure convenient to store and to transport.

### BACKGROUND OF THE INVENTION

[2] Handsaws, including a hacksaw, are common, hand tools and can be used for cutting through a variety of materials. A conventional hacksaw structure has a rigid support, a handle secured to a proximal end of the support and a front lever attached to a distal end of the support. As with any cutting instrument, it is desirable to store a hacksaw in a save manner minimizing a storage space and to provide the hacksaw with a portable structure that can by easily carried by the user.

[3] U.S. Pat. No. 4,835,869 discloses a convertible hacksaw that can be used as a saber saw. Structurally, the disclosed hacksaw can be adjusted from the conventional configuration to the configuration associated with the saber saw by pivoting a front lever in a position, in which the front lever is aligned with a support. Such conversion, however, does not reduce the overall size of the hacksaw, but simply adds to a greater length.

[4] U.S. Pat. No. 5,873,170 discloses a saw having a rotatable front lever and a pivotable handle. While the front lever is capable of rotating about a distal end of the support so that it extends parallel to the support and toward the support's proximal end, the handle has a limited angular displacement. Accordingly, compactness of the saw still remains problematic.

[5] It, therefore, desirable, to provide a hacksaw having an adjustable structure that can drastically reduce the overall size of the hacksaw as the latter is being transported or stored.

### SUMMARY OF THE INVENTION

[6] This is attained by the present invention, which discloses a handsaw provided with a handle and a front lever mounted pivotally on opposite ends of a support. To minimize a storage space necessary for storing the inventive handsaw, the handle and the front lever are rotated about parallel axes in a rest position in which both the front lever and the handle extend coplanar with the support between its opposite ends.

[7] The support can be U-shaped and can have a trough extending between the opposite ends of the support and receiving the front lever and the handle as these rotate in respective rest positions in which both the handle and the front lever are flanked by sides of the trough. Alternatively, the front lever and the handle can be dimensioned to have their inner surfaces extending complementary to and flanking the opposite sides of the support. In either case, as the front lever and the handle are displaced in the rest positions, the hand saw features a linear, compact structure.

[8] In accordance with another aspect of the invention, the hand saw according to the invention has a blade tensioner mounted pivotally on the front lever and shaped to apply a tensioning force to a blade mounted between the front lever and the handle. The blade tensioner is shaped to pivot relative to the front lever about a first pivot axis and has a pin extending along another pivot axis spaced from and parallel to the first pivot axis for rotatably receiving a blade adjuster attached to the blade. The blade tensioner is shaped so that as it pivots relative to the front lever, the blade adjuster is displaceable linearly outwards and, thus, applies a tensioning force to the attached blade.

[9] In accordance with another feature of the invention, the front lever, the handle, the blade tensioner and adjuster pivot about parallel axes to provide a compact structure. As a result of such a structure, these components are folded so that while the support accommodates the handle and the front lever, the latter is capable to accommodate the blade tensioner to provide the linear structure of the hand saw, when the latter is not in use.

[10] Also, the trough of the support is capable of receiving the blade, so that when the inventive hand saw is required to be carried or transported at a distance, it not only occupies insignificant space, but it is also safe to transport and easy to reassemble.

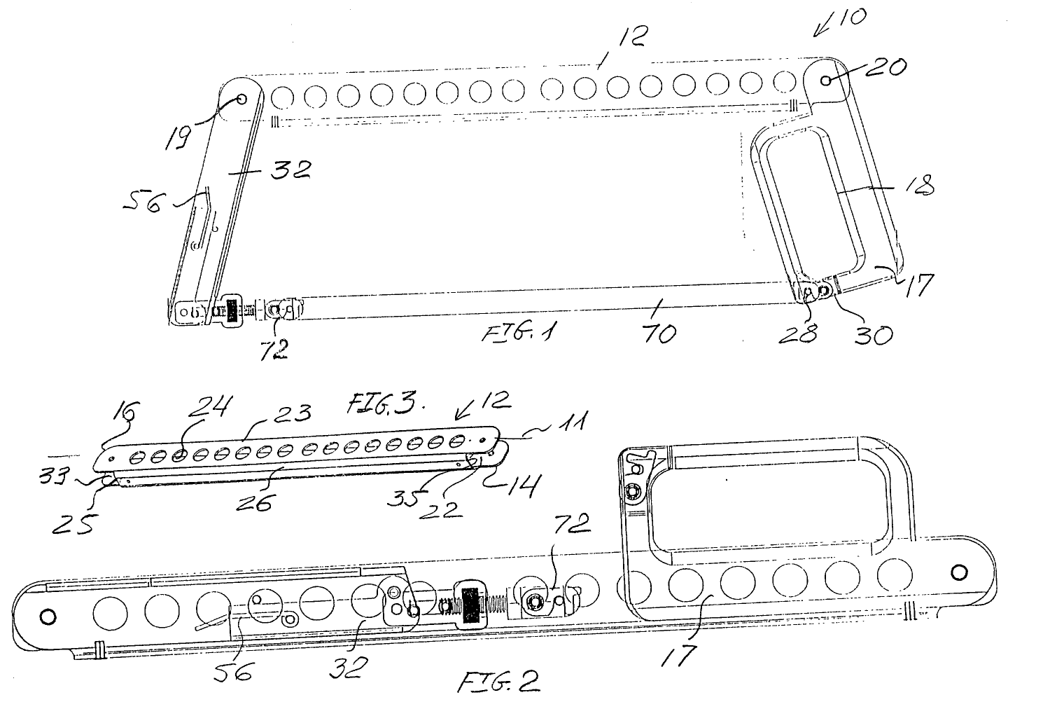

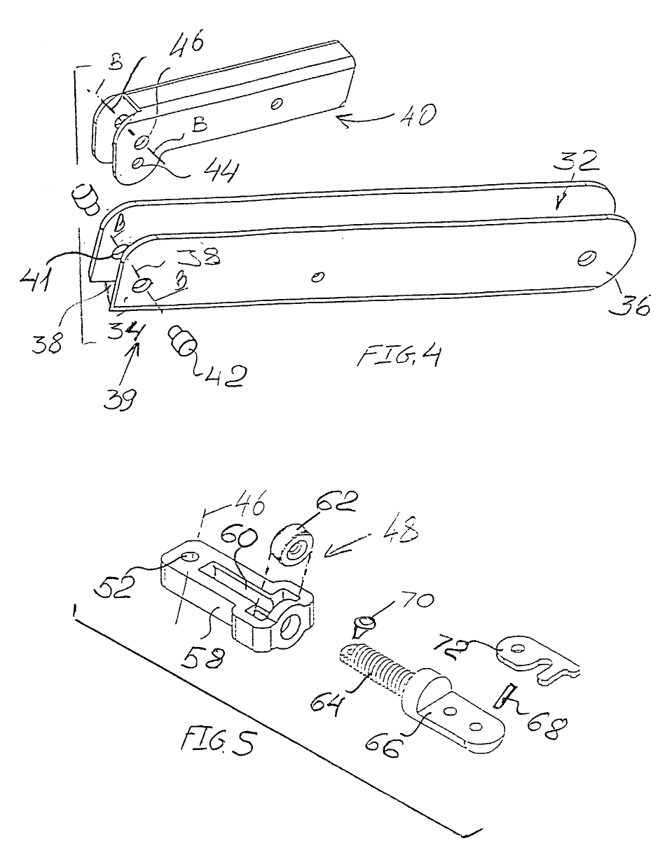

### BRIEF DESCRIPTION OF THE DRAWINGS

[11] The above and other objects, features and advantages will become more readily apparent from the specific description of the preferred embodiment illustrated by the following drawings, in which:

[12] FIG. 1 is a side view of a handsaw shown in an assembled position according to the invention;

[13] FIG. 2 is a side view of the handsaw of FIG. 1 shown in a disassembled position;

[14] FIG. 3 is an isometric view of a support of the handsaw shown in FIG. 1;

[15] FIG. 4 is an exploded view of a blade tensioner in combination with a front lever of the handsaw of FIG. 1; and

[16] FIG. 5 is an exploded view of a blade adjuster.

### DETAILED DESCRIPTION OF PREFERRED EMBODIMENT

[17] Referring to FIGS. 1-5, a foldable hand saw 10 essentially has an elongated support 12 extending along a longitudinal support axis 11 between a proximate 14 and distal 16 end of the support 12. Structural compactness of the hand saw 10 is achieved by mounting a handle 18 and a front lever 32 on the proximal 14 and distal 16 ends, respectively, so that they are capable of rotating between operative and rest positions. As shown in FIG. 2, the front lever 32 and the handle 18 are displaceable to their respective rest positions, in which the front lever and the handle extend coplanar with the support 12 between its proximal 14 and distal 16 ends.

[18] Turning specifically to FIG. 3, the support 12 is assembled of a pair of support sides 23 bridged by a support bottom 26, so that the support 12 has a U shape with a trough 24 opened outwards from the bottom 26. The trough 24 is dimensioned to receive the front lever 32 and at least a handle support 17 so that they extend within the trough 24 towards one another and are flanked by the support sides 23, as shown in FIG. 2.

[19] The support bottom 26 has end cutouts 33 and 22 formed to receive ends of the front lever 32 and the handle 18 rotatable about lever 19 and handle 20 pins, respectively, which extend transversely to the support axis 11 and attach the pivotable components to the support 12. In addition, edges 25 and 35 of support bottom 26 block angular displacement of the front lever 32 and the handle 18 as they reach their respective operative positions, as shown in FIG. 1

[20] The handle 18 is provided with a stud 28 projecting from the handle parallel to the lever 19 and handle 20 pins and a blade clamp 30 rotatable to secure a blade 70 on the handle 18 in its operative position.

[21] Turning to FIG. 4, the front lever 32 is provided with a pair of spaced flanks 34, 36 and a bottom 38 which, when the front lever 32 rotates to its rest position, opposes the bottom 26 of the support 12. The front lever 32 is so dimensioned that it is fully received within the trough 24.

[22] A free end 39 of the front lever 32 receives between its flanks 36 a blade tensioner 40, which pivots about a pivot axis B-B between a tensioning or rest position, in which the blade tensioner 40 extends parallel the front lever 32, as shown in FIGS. 1 and 2. A free end of the blade tensioner 40 has a release lever 56 (FIG. 1) displaceable angularly in response to an external force applied by the user and pulling therealong the blade tensioner 40 out of its tensioning or rest position.

[23] The opposite end of the blade tensioner 40 is formed with a pair of openings 46, which are aligned with openings 41 of the front lever 32, so that each pair of the openings 41 and 46 is traversed by a respective rivet 42 extending into having a length substantially equal to a cumulative thickness of thus coupled flank 36 of the front lever 32 and a respective side of the blade tensioner 40.

[24] To mount the blade 70, a blade adjuster 48 (FIG. 5) is rotatably mounted on a pin (not shown) extending through openings 44 (FIG. 4), which is formed in the blade tensioner 40, and a through hole 52 provided in a rocker arm 58 of the blade adjuster 48. Upon displacing the blade tensioner 40 from its tensioning or rest position, the blade adjuster can receive one of the blade ends on a stud 68 provided in a screw holder 66, whereas the other blade end is mounted on the stud 28 of the handle 18. To effectuate the linear displacement, the blade adjuster 48 has a screw 64 attached to the screw holder 66 and inserted into a longitudinal, central recess 60 of the rocker arm 58 through a thumbnut 62 engaging the screw so that when the user rotates the nut the screw linearly moves. Finally, a screw 70 removably attachable to the end of the screw 64 prevents the screw holder 66 from rotating within the central recess 60 by being dimensioned to be only slightly smaller than s width of the central recess.

[25] Once the blade 70 is mounted between the handle 18 and the blade adjuster 48, the blade clamps 30 and 72 rotate to secure the blade in its mounting position. Since the pin extending through the openings 44 is offset from the axis B-B, about which the blade tensioner 40 pivots relative to the front lever 32, angular displacement of the blade tensioner 40 towards its tensioning position causes the blade adjuster 48 to move linearly outwards and to apply a tensioning force to the blade 70. Note that the tensioning position of the blade tensioner 40, as shown in FIG. 1, corresponds to its rest position, as illustrated in FIG. 2.

[26] Although in the foldable handsaw 10, as illustrated in FIGS. 1 and 2, the handle 18 and the front lever 32 are rested inside the trough 24 of the support 12, it is easy to modify the inventive handsaw by dimensioning, for example, the front lever 32 so that a distance between its flanks 36 is greater than a distance between the sides 23 of the support 12. Accordingly, when the front lever 32 moves towards its rest position, the opposite sides 23 of the support are located between the flanks 36. Analogously, the handle 18 can be shaped and dimensioned so that the opposite sides of the handle 18 flank the support sides 23 in the rest position of the handle 18. Furthermore, the front lever 32 and the handle 18 are so dimensioned that as these components are displaced in the rest positions, they frictionally engage the support 12 with a force sufficient to prevent mutual displacement of the engaged components without applying an external force.

[27] The hand saw as disclosed above can be subjected to obvious modification without departing from the scope of the invention, as recited in the following claims.

What is claimed is:

1. A hand saw comprising:
a U-shaped support provided with a trough extending between opposite ends of the support;
a handle pivotally mounted on one of the opposite ends of the support; and
a front lever pivotally mounted on the other end of the frame, the handle and front lever rotatable between a rest position, in which the handle and the front lever are received in the trough of the support, and an operative position, in which the handle and the front lever extend transversely to the frame and receive a blade removably mounted on free ends of the handle and front lever.

2. The hand saw according to claim 1, further comprising a blade tensioner mounted pivotally on the free end of the front lever by one of the tensioner opposite ends and pivotable between a tensioning position, in which the blade tensioner extends parallel to the front lever, and a plurality of loading positions in which the blade tensioner extends transversely to the front lever.

3. The hand saw according to claim 2, wherein the front lever has spaced flanks bridged by a lever bottom and defining an inner space therebetween dimensioned to receive the blade tensioner in the tensioning position thereof.

4. The hand saw according to claim 3, wherein the blade tensioner has a U-shape defined between spaced sides and a tensioner bottom bridging the spaced sides, the blade tensioner rotating so that when the blade tensioner is displaced in the tensioning position, the sides of the tensioner extend within the inner space of and are juxtaposed with the sides of the front lever and the tensioner bottom closes the inner space of the front lever.

5. The hand saw according to claim 4, wherein a free end of the blade tensioner has a release lever extending over the free end of the blade tensioner and actuated by an externally applied force for displacing the blade tensioner between the tensioning position and the loading positions.

6. The hand saw according to claim 5, wherein the release lever, the blade tensioner, the front lever and the handle are pivotable about respective parallel axes.

7. The hand saw according to claim 2, further comprising a blade adjuster mounted pivotally on the one end of the blade tensioner and rotatable about a pivot axis spaced from and parallel to the axis, about which the blade tensioner and the front lever pivot relative to each other, the blade tensioner pivots between a rest position, in which the blade adjuster extends from the one end of the blade tensioner substantially parallel to the front lever and a mounting position, in which the blade adjuster extends parallel to and spaced from the support.

8. The hand saw according to claim 4, further comprising a pair of spaced rivets each having a length sufficient to penetrate through a respective pair of the juxtaposed flank of the front lever and side of the blade tensioner and serving as the axis about which the blade tensioner rotates relative to the front lever.

9. The hand saw according to claim 7, wherein the blades adjuster includes:
a screw holder provided with a screw,
a screw bracket mounted on the free end of the blade tensioner and having an elongated recess which extends transversely to the axes of pivot; and
a thumb nut received in the elongated recess and threadedly receiving the screw so that the when the thumb nut is actuated the screw holder displaceable toward and away from the free end of the blade tensioner.

10. The hand saw according to claim 9, wherein the screw holder has a first stud and the free end of the handle has a second stud dimensioned to penetrate stud holes formed on opposite ends of the blade.

11. A hand saw comprising:
an elongated support extending in a support plane between opposite ends;
a front lever having mounted on one of the opposite ends of the support and pivotable about a lever axis between a rest position, in which front lever extends coplanar with the support between the opposite ends of the support, and an operative position, in which the front lever lies in a plane extending transversely to the support plane; and
a handle mounted pivotally on the other end of the support and pivotable about a handle axis, which extends parallel to the lever axis, between a respective rest position, in which the handle extends coplanar with the support between the opposite ends thereof, and a respective operative position spaced angularly from the respective rest position.

12. The hand saw according to claim 11, wherein the elongated support has two spaced elongated sides and the front lever two spaced flanks, the spaced flanks being mounted between the spaced sides and are juxtaposed therewith in the rest position of the front lever.

13. The hand saw according to claim 11, wherein the elongated support has two spaced elongated sides attached to a pair of spaced flanks of the front lever so that when the front lever pivots in the rest position, the sides of the support are juxtapose with and extend between the flanks of the front lever.

14. The hand saw according to claims 11, further comprising a blade tensioner supported pivotally on a free end of the front lever so that when the front lever is displaced in the rest position thereof, the blade tensioner extends coplanar with the front lever and with the support.

15. The hand saw according to claim 14, further comprising a blade adjuster mounted on the blade tensioner and rotatable about an axis of rotation parallel to and spaced from a pivot axis, about which the blade tensioner and the front lever pivot relative to one another.

16. The hand saw according to claim 11, wherein the handle has a U-shaped handle support flanking the support in the rest position of the handle.
